(19) United States
(12) Patent Application Publication
(10) Pub. No.: US 2026/0105501 A1
(43) Pub. Date: Apr. 16, 2026

(54) GENERATING DATA-DRIVEN MICROSITES

(71) Applicant: Walmart Apollo, LLC, Bentonville, AR (US)

(72) Inventors: Mohan Srinivas Palavancha, Bengaluru (IN); Pavan Dileep Tonapi, Bengaluru (IN); Jagdish Prasad Agarwal, Bengaluru (IN); Kumar Mridul Vishal, Bengaluru (IN); Pratyush Pushkar, Bengaluru (IN); Chandra Prakash Bhagtani, Bangalore (IN)

(73) Assignee: Walmart Apollo, LLC, Bentonville, AR (US)

(21) Appl. No.: 19/359,557

(22) Filed: Oct. 15, 2025

Related U.S. Application Data
(60) Provisional application No. 63/708,146, filed on Oct. 16, 2024.

(51) Int. Cl. G06Q 30/0601

(52) U.S. Cl. CPC G06Q 30/0601

(57) ABSTRACT

Systems and methods for generating, updating, and otherwise maintaining data-driven microsites are disclosed. The system is configured to identify a triggering condition that includes criteria related to a user-initiated event, a temporal event, or an analytical event. The system then generates a target microsites based on that criteria, wherein the generation includes the use of machine learning models and algorithms to generated data-backed content, arrangements, and keywords in the form of a microsite that is catered to a specific product, product line, or service identified in the criteria. The customized microsite is then published onto an ecommerce marketplace platform.

### CROSS REFERENCE TO RELATED APPLICATIONS

This application claims the benefit of and priority to U.S. Provisional Patent Application No. 63/708,146, filed on Oct. 16, 2024, the contents of which are incorporated herein by reference in their entirety.

### TECHNICAL FIELD

This disclosure relates generally to the use of machine learning models and algorithmic methods to generate, update, and maintain data-driven microsites.

### BACKGROUND

An ecommerce marketplace platform, e.g., an ecommerce marketplace website, can hosts digital storefronts, which are microsites that serve as platforms for vendors, e.g., brands, creators, third-party sellers, etc., to offer their products and services to potential online customers. The presentation of a vendor's digital storefront, and potential customers' experiences interfacing therewith, can have a significant impact on sales driven by the vendor's digital storefront and in relation to competitor vendors' digital storefronts.

### BRIEF DESCRIPTION OF THE DRAWINGS

To facilitate further description of the embodiments, the following drawings are provided in which:

FIG. 1 illustrates a front perspective view of a computer system, according to some example embodiments.

FIG. 2 illustrates a representative block diagram of elements included in the circuit boards inside a chassis of the computer system of FIG. 1, according to some example embodiments.

FIG. 3 illustrates a block diagram of a system that can generate, update, and maintain data-driven microsites, according to some example embodiments.

FIG. 4 illustrates a workflow diagram of different moments in time during which the data-driven generative storefront system, introduced in FIG. 3, is generating, updating, and maintaining the data-driven microsites, according to some example embodiments.

FIG. 5 illustrates an overview workflow diagram of the data-driven generative storefront system, according to some example embodiments.

FIG. 6 is a workflow diagram of the data-driven generative storefront system that illustrates classification and clustering, according to some example embodiments.

FIG. 7 is a workflow diagram of the data-driven generative storefront system that illustrates the use of brand safety policies when generating copy content, creatives, and page metadata using multiple machine learning models, according to some example embodiments.

FIG. 8 is a workflow diagram of the data-driven generative storefront system that illustrates the use of a multimodal large language model (LLM) when generating the copy content, according to some example embodiments.

FIG. 9 is a workflow diagram of the data-driven generative storefront system that illustrates the use of an image generation machine learning model when generating the creatives, according to some example embodiments.

FIG. 10 is a workflow diagram of the data-driven generative storefront system that illustrates the generation of multiple versions of pages, according to some example embodiments.

FIG. 11 is a workflow diagram of the data-driven generative storefront system that illustrates the use of the multimodal LLM when generating the copy content, the creatives, and the page metadata, according to some example embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same or similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION

The process of creating, customizing, and regularly updating a digital storefront is often daunting, tedious, inefficient, and costly for vendors. For example, many vendors lack a proficiency in web design and graphic design and incur considerable expenses enlisting relevant professionals therefor. Vendors having such a proficiency themselves may still incur an associated cost with respect to diverting their resources. Although vendors can presently avail themselves of categorical product- or service-themed templates to create a digital storefront, these templates are often generic, devoid of guidance/analysis for efficacy, external to an ecommerce marketplace, and significantly limited with respect to customizability, while still needing active involvement of vendors in creating, customizing, and/or continually updating digital storefronts. This manual, error-prone process that vendors often fall victim to or fail to even initiate the process of due to lack in proficiency in web design and graphic design may also be referred to as a “cold start” problem.

Embodiments disclosed herein provide for data-driven microsites. As used herein, microsites may be a specific webpage or set of webpages that serve as a digital storefront for a single vendor, e.g., a single brand, creator, or third-party seller. A single microsite may include content from one or more product lines and one or more services that are being offered for sale by the single vendor. In a first example, a given microsite may include images and corresponding text, creatives, and other page modules with content that collectively pertain to blue ink pens, black ink pens, and red ink pens that are being offered for sale by a given ink pen manufacturer. In a second example, a given microsite may include information pertaining to multiple clothing items, e.g., dresses, skirts, pants, etc., of a given clothing vendor.

Furthermore, both the first and second examples of respective microsites may be hosted on the same ecommerce marketplace website. Thus, a plurality of microsites from different respective companies, brands, vendors, third-party sellers, etc. may all be published and made accessible via the same ecommerce marketplace website. Each of the microsites is customized, tailored, or otherwise oriented towards a specific brand, vendor, or third-party seller that is offering product(s) and, in some example embodiments, service(s) for sale via the ecommerce marketplace website.

In some example embodiments, the microsites may be individual or small sets of webpages that conform to brand safety policies and guidelines of the larger ecommerce marketplace platform. These types of policies and guidelines are additionally described below.

Moreover, for ease of discussion herein, a “webpage” may also be referred to as a “page.” See also page generation component 356, page module selection 524, page layout 526, page versioning 530, and so on. It should also be understood that a “digital” storefront may also be referred to as an “online” storefront, and that the data-driven generative storefront systems and methods described herein thus refer to generation of a digital (online) storefront.

As aforementioned, a significant challenge arises from a “cold start” problem and a learning curve associated with onboarding, restricting the scalability of brand pages, etc. Given the scale of products and brands on ecommerce marketplace platforms, it is difficult for an organization to create and continually maintain focused pages to promote these products using a manual centralized process controlled by the operator of the ecommerce marketplace. Enabling users to create and establish their online presence can be beneficial to all parties.

Generative storefronts may be useful for overcoming these limitations, at least. Generative storefronts provided herein enable a self-service mechanism for vendors to generate, update, and otherwise maintain generative storefronts, empowering brand owners to craft their own narratives through customizable layouts and creative tools.

Embodiments disclosed herein provide a scalable solution that not only addresses the “cold start” problem, but also facilitates the creation of customized and engaging brand pages, such as on a dynamic basis, in a substantially autonomous manner. In various embodiments, generative digital storefronts automate the generation of digital storefront pages for vendors, such as with modules that are rich in content and tailored to the specific digital storefront parameters, such as products/services, target audience(s), storytelling, and brands. Digital storefront microsites that are generated using the systems and methods described herein can be uniquely customized, and incorporate different storytelling/thematic elements, module layouts, and/or modules, etc.

Embodiments can leverage generative artificial intelligence (GenAI) for the generation of microsites, such as by generating creatives, headlines, sub-headlines, copy content, modules, modules layouts, search engine optimization metadata/keywords, etc. Embodiments can use a statistical model to identify the relevant SKUs to showcase or feature to potential customers of the vendor's microsite. Embodiments are also capable of generating multiple versions of digital storefronts based on, for example, trends and seasonality, e.g., holidays and events throughout the year.

Furthermore, the microsites generated for these digital storefronts can be designed to adhere to an ecommerce marketplace's brand safety policies and guidelines. Embodiments can also generate optimized metadata, e.g., metatags and keywords, related to the digital storefront, effectively boosting search engine optimization equity. Embodiments can further solve a “cold start” problem for vendors in creating digital storefront pages at scale, which can bring a vendor in par with competition. Embodiments can also enable vendors to establish a digital presence in a substantially automated manner, thus saving vendors time and money.

Embodiments can include a system that includes a processor; and a non-transitory computer-readable medium storing computing instructions that, when executed on the processor, can cause the processor to identify a triggering condition, wherein the triggering condition comprises criteria regarding a user-initiated event, a temporal event, or a data-driven event; cause a target microsite to be generated for an ecommerce marketplace platform based on the criteria, wherein, to generate the target microsite, the program instructions further cause the processor to: classify, via a classification and clustering algorithm, the target microsite as pertaining to a given class of products or services based on the criteria and on information from a product and service catalog; cluster, via the classification and clustering algorithm, a set of published microsites that correspond to the target microsite based on a given threshold of similarity in respective features of the set of published microsites and the target microsite, wherein the respective features of the set of published microsites comprise at least one of categories, attributes, contents, locations, target audiences, and at least one of target users, products offered for sale, product descriptions, or brand stories; select, via the classification and clustering algorithm, a given page module from a given one of the set of published microsites that is identified as being associated with a higher user click feed data than another page module from the given set of published microsites; and generate a page layout for the target microsite based, at least in part, on the selected page module; and cause the target microsite to be published on the ecommerce marketplace platform according to the page layout.

In some example embodiments of the system, the program instructions can further cause the processor to generate copy content, a creative, or search engine optimization metadata of the target microsite, in addition to the page layout; and cause the target microsite to be published on the ecommerce marketplace platform according to the page layout and to the copy content, the creative, or the search engine optimization metadata of the target microsite. The program instructions can further cause the processor to verify that the copy content, the creative, or the search engine optimization metadata of the target microsite are in compliance with brand safety policies, wherein the search engine optimization metadata comprises keywords that are searchable by a web crawler.

In some example embodiments of the system, the program instructions can further cause the processor to provide multiple candidate variations of the target microsite to a user prior to publication of the target microsite, wherein the candidate variations differ from one another in at least one of page layouts, copy contents, creatives, search engine optimization metadata, or a number of products offered for sale on the target microsite; and receive an indication from the user regarding a given one of the candidate variations to be used when the target microsite is published on the ecommerce marketplace platform.

Embodiments can include a method for generating data-driven microsites. The method includes identifying a triggering condition, wherein the triggering condition comprises criteria regarding a user-initiated event, a temporal event, or an analytical event; generating a target microsite to be published on an ecommerce marketplace platform based on the criteria, wherein, the generating the target microsite comprises: classifying, via a classification and clustering algorithm, the target microsite as pertaining to a given class of products or services based on the criteria and on information from a product and service catalog; clustering, via the classification and clustering algorithm, a set of published microsites that correspond to the target microsite based on a given threshold of similarity in respective features of the set of published microsites and the target microsite, wherein the respective features comprise at least one of categories, attributes, contents, locations, or target audiences; selecting, via the classification and clustering algorithm, a given page module from a given one of the published microsites that is identified as being associated with a higher user click feed data over a given interval of time than another page module from the given set of published microsites; and generating a page layout for the target microsite based, at least in part, on the selected page module; and publishing the generated target microsite on the ecommerce marketplace platform according to the page layout.

In some example embodiments of the method, the method further comprises generating a page layout for the target microsite, wherein the generating the page layout for the target microsite comprises modifying a page layout of the published microsite that corresponds to the selected page module; and publishing the generated target microsite on the ecommerce marketplace platform. Moreover, the generating the page layout for the target microsite may further comprise arranging copy content and creatives within the page layout based on a ranking of click feeds that correspond to the copy content and the creatives.

In some example embodiments of the method, the method further comprises extracting the respective features of the target microsite from at least one of user input data, content management system data, product and service catalogue data, user analytics data, or brand safety policy data.

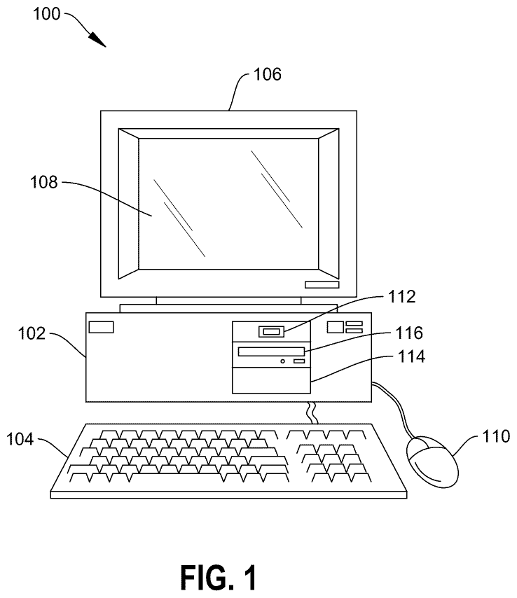

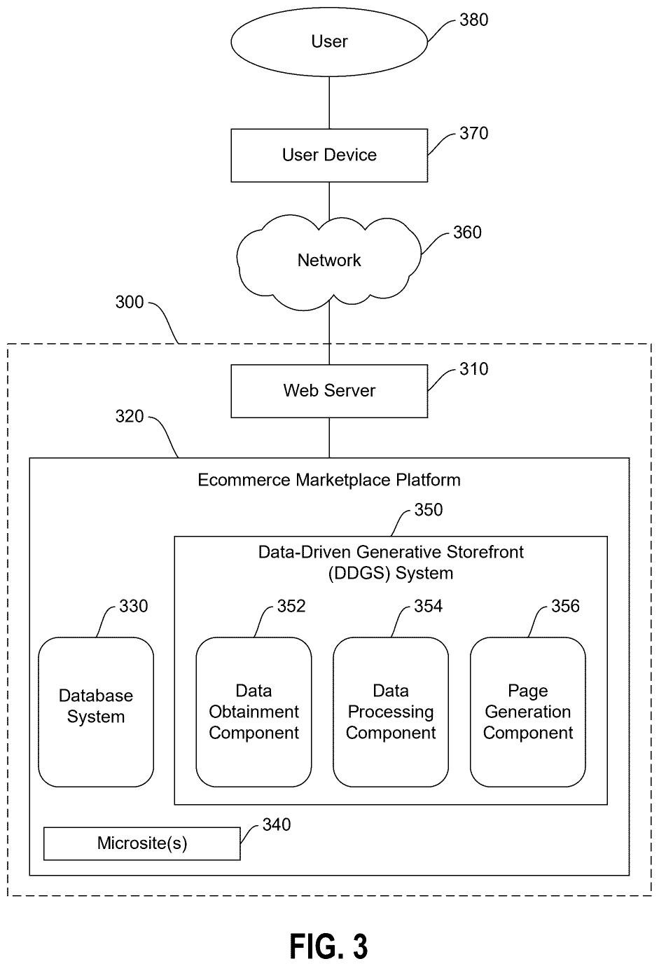

FIG. 1 illustrates a front perspective view of a computer system that is suitable for implementing the embodiment of the system 300 disclosed in FIG. 3, according to some example embodiments.

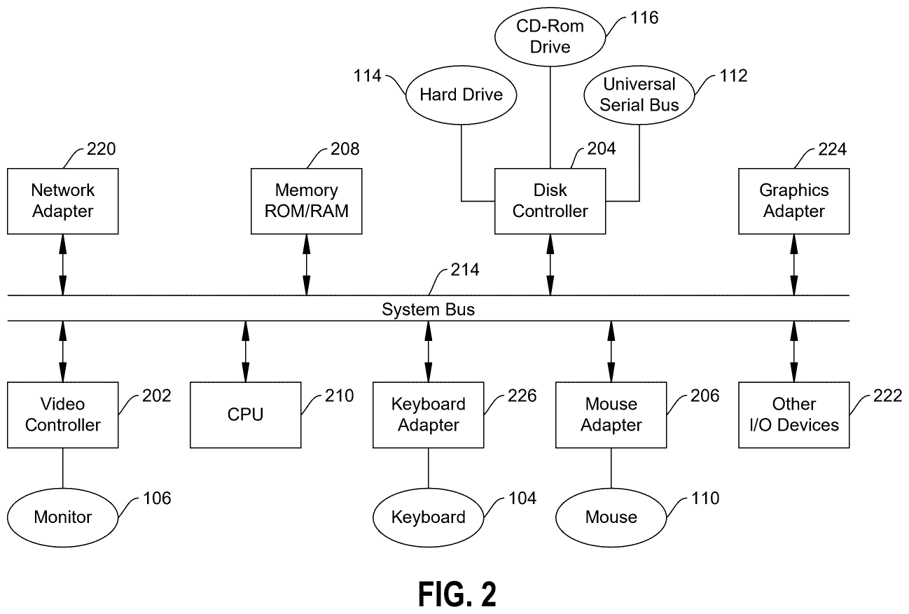

Turning to the drawings, FIG. 1 illustrates an embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all the techniques described herein. Computer system 100 can comprise chassis 102 containing one or more circuit boards (not shown), a universal serial bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

FIG. 2 illustrates a representative block diagram of elements included in the circuit boards inside a chassis of the computer system of FIG. 1, according to some example embodiments.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to USB port 112 (FIGS. 1-2)), the hard drive 114 (FIGS. 1-2), and/or CD-ROM, DVD, Blu-Ray, or other suitable media, such as media configured to be used in the CD-ROM and/or the DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further examples of operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise the CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control the hard drive 114 (FIGS. 1-2), USB port 112 (FIGS. 1-2), and CD-ROM and/or the DVD drive 116 (FIGS. 1-2). In other embodiments, distinct units can be used to control each of these devices separately.

In some example embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown) or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or the DVD drive 116, on the hard drive 114, or in memory storage unit 208 (FIG. 2) are executed by the CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100 and can be executed by the CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some example embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In some example embodiments, computer system 100 may comprise a portable computer, such as a laptop computer. In some other embodiments, computer system 100 may comprise a mobile device, such as a smartphone. In some additional embodiments, computer system 100 may comprise an embedded system.

FIG. 3 illustrates a block diagram of the system 300 that can be utilized for implementing various processes, such as those illustrated in workflows 400, 500, 600, 700, 800, 900, 1000, and 1100 for generating, updating, and otherwise maintaining data-driven microsites, according to some example embodiments.

System 300 is merely an example, and embodiments of the system are not limited to the embodiments presented herein. The system can be employed in many different embodiments or examples not specifically depicted or described herein. In some example embodiments, particular elements, modules, or systems of the system 300 can perform various procedures, processes, and/or activities. In other embodiments, the procedures, processes, and/or activities can be performed by other suitable elements, modules, or systems of the system 300. In some example embodiments, the system 300 can include an ecommerce marketplace platform 320 (e.g., an ecommerce marketplace website), a data-driven generative storefront system 350, one or more microsites 340, a database system 330, and a web server 310. The ecommerce marketplace platform 320 can include the one or more microsites 340, the database system 330, and the data-driven generative storefront system 350. Collectively, the microsites 340 refer to respective microsites for various sellers, and, in some example embodiments, a given seller can have more than one microsite within the ecommerce marketplace platform 320.

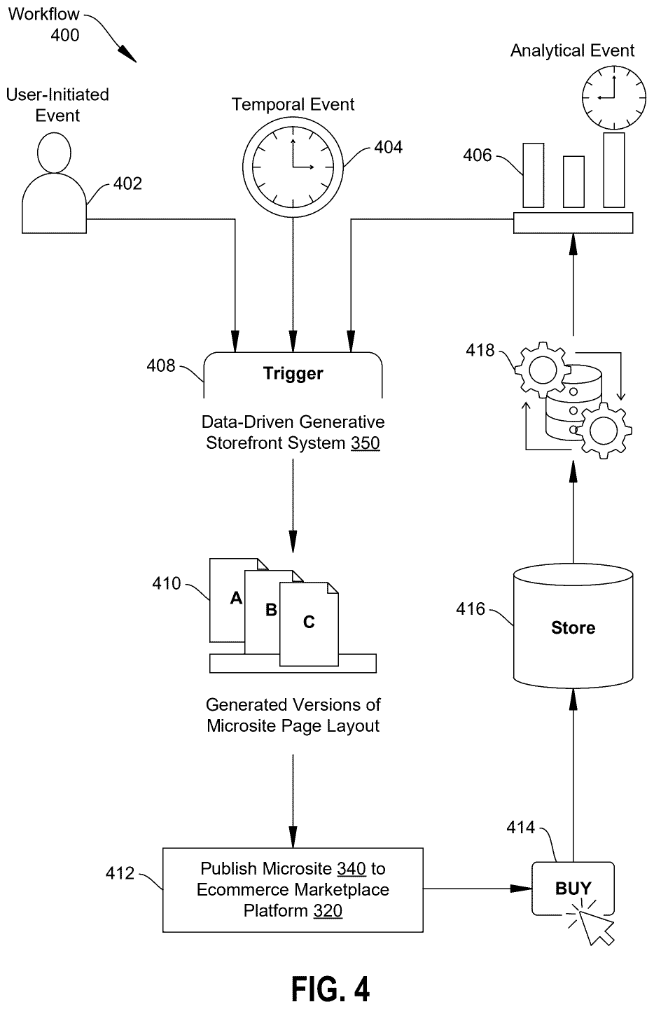

The data-driven generative storefront system 350 can include a data obtainment component 352, a data processing component 354, and a page generation component 356, examples of which are additionally described herein with regard to FIGS. 4-11.

In some example embodiments, the data-driven generative storefront system 350 can be external to the ecommerce marketplace platform 320 but connected thereto, e.g., via the web server 310 and the network 360, such as when the data-driven generative storefront system 350 and the ecommerce marketplace platform 320 are hosted on different web servers, websites, and/or computing devices. Generally, therefore, the system 300 can be implemented with hardware and/or software, as described herein. In some example embodiments, part or all the hardware and/or software can be conventional, while in these or other embodiments, part, or all the hardware and/or software can be customized (e.g., optimized) for implementing part or all the functionality of the system 300 described herein.

One or more of the data-driven generative storefront system 350 or the web server 310 can be a computer system, such as the computer system 100 shown in FIG. 1 and as described above, and can be a single computer, a single server, a cluster or collection of computers or servers, or a cloud of computers or servers. In another embodiment, a single computer system can be used for the data-driven generative storefront system 350 and/or the web server 310. Additional details regarding the data-driven generative storefront system 350 and the web server 310 are described herein.

In some example embodiments, the web server 310 can be in data communication through the network 360 with one or more user devices, such as a user device 370. The user device 370 can be part of the system 300 or external to system 300. The network 360 can be the Internet or another suitable network. In some example embodiments, the user device 370 can be used by users, e.g., vendors, which are collectively illustrated by user 380 in FIG. 3. In many embodiments, the web server 310 can host one or more websites and/or mobile application servers. For example, the web server 310 can host an ecommerce marketplace platform 320 or provide a server that interfaces with an application, e.g., a mobile application, on the user device 370, which can allow users, e.g., user 380, to interface with the data-driven generative storefront system 350, such as for requesting a generation of a data-driven microsite 340 for the user 380.

In some example embodiments, an internal network that is not open to the public can be used for communications between the data-driven generative storefront system 350 and the web server 310 within the system 300. Accordingly, in some example embodiments, data-driven generative storefront system 350, and the software used by such systems, can refer to a back end of the system 300 operated by an operator or administrator of the system 300, and the web server 310, and the software used by such systems, can refer to a front end of system 300, as can be accessed and used by the users, such as the user 380, using the user device 370. In these or other embodiments, the operator or administrator of the system 300 can manage the system 300, the processor(s) of the system 300, and the memory storage unit(s) of the system 300 using the input device(s) and/or display device(s) of the system 300.

In some example embodiments, the user devices, e.g., the user device 370, can include desktop computers, laptop computers, mobile devices, and other endpoint devices used by the users, e.g., the user 380. A mobile device can refer to a portable electronic device, e.g., an electronic device easily conveyable by hand by a person of average size, with the capability to present audio and visual data, e.g., text, images, videos, music, etc. For example, a mobile device can include at least one of a digital media player, a cellular telephone, e.g., a smartphone, a personal digital assistant, a handheld digital computer device, e.g., a tablet personal computer device, a laptop computer device, e.g., a notebook computer device, a netbook computer device, a wearable user computer device, or another portable computer device with the capability to present audio and/or visual data, e.g., images, videos, music, etc. Thus, in many examples, a mobile device can include a volume and weight sufficiently small as to permit the mobile device to be easily conveyable by hand. For example, a mobile device can occupy a volume of less than or equal to approximately 1790 cubic centimeters, 2434 cubic centimeters, 2876 cubic centimeters, 4056 cubic centimeters, or 5752 cubic centimeters. Further, in these embodiments, a mobile device can weigh less than or equal to 15.6 Newtons, 17.8 Newtons, 22.3 Newtons, 31.2 Newtons, or 44.5 Newtons.

Mobile devices can include (i) an iPod®, iPhone®, iTouch®, iPad®, MacBook® or similar product by Apple Inc. of Cupertino, California, United States of America, or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, one or more of the system 300, the data-driven generative storefront system 350, and the web server 310 can include one or more input devices, e.g., a keyboard, a keypad, a pointing device such as a computer mouse, a touchscreen display, a microphone, etc., and can comprise a display device, e.g., a monitor, a touch screen display, a projector, etc. In these or other embodiments, one or more of the input devices can be similar or identical to the keyboard 104, illustrated in FIG. 1, and the mouse 110, also illustrated in FIG. 1. Furthermore, one or more of the display devices can be similar or identical to the monitor 106, illustrated in FIG. 1, and the screen 108, illustrated in FIG. 1. The input devices and the display devices can be coupled to one or more of the system 300, the data-driven generative storefront system 350, and the web server 310 in a wired manner or a wireless manner, and the coupling can be direct or indirect, as well as local or remote. As an example of an indirect manner, which may also be referred to herein as a remote manner, a keyboard-video-mouse (KVM) switch can be used to couple the input device(s) and the display device(s) to the processor(s) and the memory storage unit(s). In some example embodiments, the KVM switch can also be part of the data-driven generative storefront system 350 and the web server 310. In a similar manner, the processors and the non-transitory computer-readable media can be local or remote to each other.

In various embodiments, the data-driven generative storefront system 350 and the web server 310 also can be connected to communicate with one or more databases such as the database system 330. The databases of the database system 330 can be stored on one or more memory storage units, e.g., non-transitory computer readable media, which can be similar or identical to the one or more memory storage units, e.g., non-transitory computer readable media, described above with respect to the computer system 100. Also, in some example embodiments, for any particular database of the database system 330, that particular database can be stored on a single memory storage unit, or the contents of that particular database can be spread across multiple ones of the memory storage units storing the one or more databases, depending on the size of the particular database and the storage capacity of the memory storage units.

The one or more databases of the database system 330 can include a structured, e.g., indexed, collection of data and can be managed by any suitable database management system(s) configured to define, create, query, organize, update, and manage databases. Such database management systems can include MySQL (Structured Query Language) Database, PostgreSQL Database, Microsoft SQL Server Database, Oracle Database, SAP (Systems, Applications, & Products) Database, and IBM DB2 Database.

The data-driven generative storefront system 350, the web server 310, and the databases connected to the database system 330 can be implemented using any suitable manner of wired or wireless communication. Accordingly, the system 300 can include any software and/or hardware components configured to implement the wired and wireless communication. Furthermore, the wired or wireless communication can be implemented using any one or any combination of wired or wireless communication network topologies, e.g., ring, line, tree, bus, mesh, star, daisy chain, hybrid, etc., and protocols, e.g., personal area network (PAN) protocol(s), local area network (LAN) protocol(s), wide area network (WAN) protocol(s), cellular network protocol(s), powerline network protocol(s), etc. PAN protocol(s) can include Bluetooth, Zigbee, Wireless Universal Serial Bus (USB), Z-Wave, etc. ; LAN and WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and protocols implemented, and vice versa. In many embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components, e.g., modulator-demodulator components, gateway components, etc.

In many embodiments, various systems of the data-driven generative storefront system 350 can include modules of computing instructions, e.g., software modules, stored at non-transitory computer readable media that operate on one or more processors. In some example embodiments, various systems of the data-driven generative storefront system 350 can be implemented in hardware. One or more of the data-driven generative storefront system 350 and/or the web server 310 can be a computer system, such as the computer system 100, and can be a single computer, a single server, or a cluster or collection of computers or servers, or a cloud of computers or servers.

FIG. 4 illustrates a workflow diagram 400 of different moments in time during which the data-driven generative storefront system 350, introduced in FIG. 3, is generating, updating, and maintaining the data-driven microsites, according to some example embodiments.

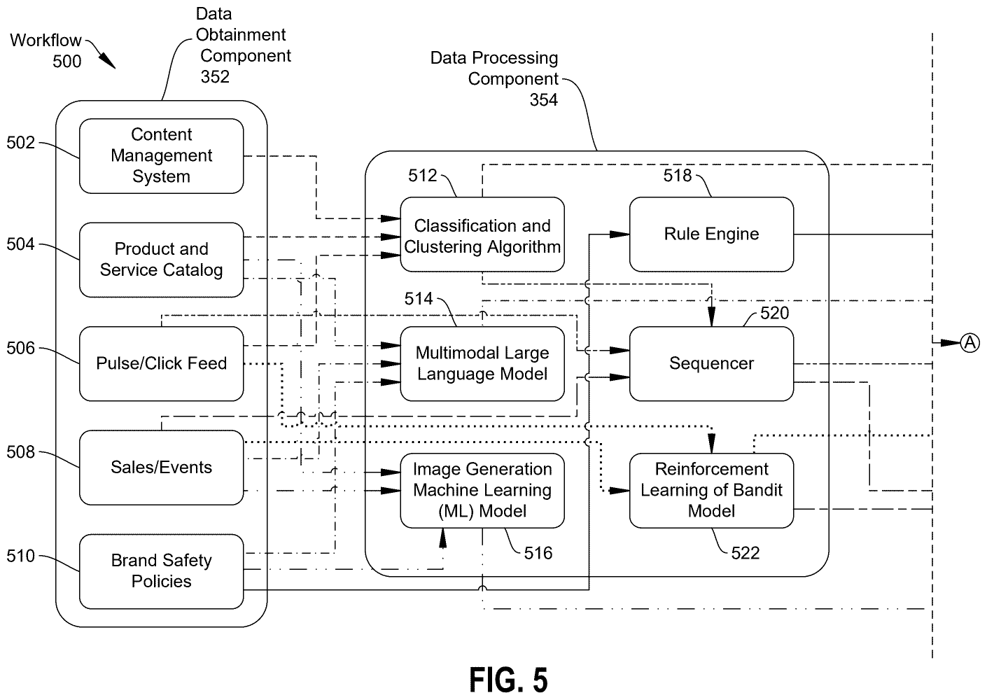

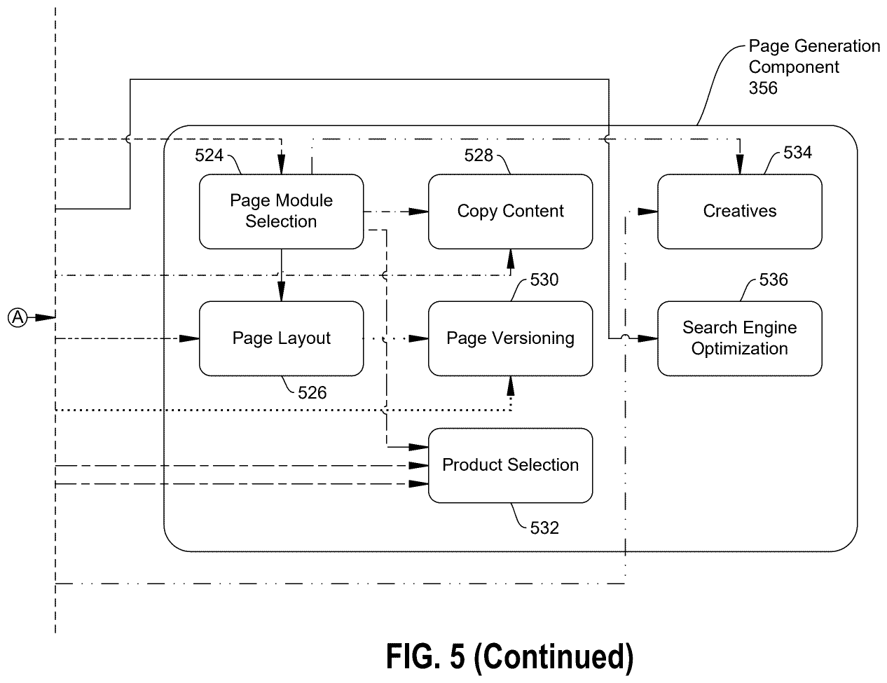

As illustrated in FIG. 4, the data-driven generative storefront system 350 may receive or identify a triggering condition at a first moment in time. In some example embodiments, the triggering condition may resemble a user-initiated event 402. The user-initiated event may also resemble a user-generated prompt that has been provided to a multimodal large language model, e.g., multimodal LLM 514 that is additionally described below with regard to FIG. 5, and which includes criteria for the generation of the target microsite 340.

In other example embodiments, the triggering condition may resemble a temporal event 404, such as criteria that enumerate dates and times for an upcoming sale or upcoming holiday.

In yet other example embodiments, the triggering condition may resemble an analytical event 406, such as criteria that detail a product launch, a recent decrease in sales, or a recent decrease in user click feeds.

After identification of the triggering condition, the data-driven generative storefront system 350 is then configured to generate a target microsite 340 for the ecommerce marketplace platform 320, as illustrated by block 408.

The implementations of the page generation component 356 are additionally described below with regard to workflow 500. In general, the data-driven generative storefront system 350 may be useful for generating a target microsite for an ecommerce marketplace platform based on at least the following.

In an example, the data-driven generative storefront system 350 classifies, via a classification and clustering algorithm, e.g., classification and clustering algorithm 512, the target microsite as pertaining to a given class of products or services based on the criteria and on information from a product and service catalog.

In another example, the data-driven generative storefront system 350 clusters a set of published microsites that correspond to the target microsite based on a given threshold of similarity in respective features of the set of published microsites and the target microsite.

In many example embodiments, the respective features can include at least one of categories, attributes, contents, locations, or target audiences. The features of the target microsite can be both pre-extracted and extracted from one or more of user input data, e.g., prompts, pre-selected criterion, reference to brand publications and an external published website, etc., content management system (CMS) data, product and service catalogue data, monitored/inputted/received user analytics data, brand safety policy and guideline data, and calendar data.

The features associated with the set of published microsites can include one or more of temporal events, user locations, click feeds, user traffic, sales, target users, featured objects, featured object descriptions, featured products, featured product descriptions, copy content, arrangements of the copy content, copy content syntax, copy content tone, copy content composition, search engine optimization metadata metrics, search engine optimization metadata keywords, brands, brand types, brand stories, inter-brand collaborations, themes, trademarks, page layout templates, module templates, tag lines, logos, headers, module arrangements, module requirements, creatives, arrangements of the creatives, creative themes, creative categories, creative color palettes, creative proportions, creative types, or creative styles.

In another example, the data-driven generative storefront system 350 selects a given page module from a given one of the set of published microsites that is identified as being associated with a higher user click feed data than another page module from the given set of published microsites. The page modules and arrangements of the one or more page modules for the target microsite can be selected to be generated based on a ranking of click feeds, e.g., minimum click feed trajectory to purchase, largest sales per click, largest number of overall clicks, etc. corresponding to the page modules of the currently published or past published microsites.

In another example, the data-driven generative storefront system 350 generates a page layout for the target microsite based, at least in part, on the selected page module. The data-driven generative storefront system 350 may also generate copy content, a creative, or search engine optimization metadata, e.g., keywords that are searchable by a web crawler, of the target microsite, in addition to the page layout, at this moment in time. Moreover, the data-driven generative storefront system 350 may verify that the copy content, the creative, or the search engine optimization metadata of the target microsite are in compliance with brand safety policies.

As then illustrated by block 410, the data-driven generative storefront system 350 may provide multiple candidate variations of the target microsite to a user, e.g., user 380, prior to publication of the target microsite, wherein the candidate variations differ from one another in at least one of page layouts, copy contents, creatives, search engine optimization metadata, or a number of products offered for sale on the target microsite. Upon receiving an indication from the user regarding a selection of one of the candidate variations, the data-driven generative storefront system is then configured to cause the target microsite to be published to the ecommerce marketplace platform 320, as indicated in block 412.

Blocks 414, 416, and 418 then illustrate a passage of time after publishing the target microsite 340. The data-driven generative storefront system 350 monitors user analytics pertaining to the published target microsite 340, and, in some example embodiments, stores those user analytics into the database system 330.

After a new product launch, or a change in sales, or a change in user click feeds pertaining to the target microsite 340, another analytical event 406 may thus be triggered, and the workflow 400 begins again. This time, the data-driven generative storefront system 350 may update at least one of copy content, arrangement of the page layout, the page module, a creative, or search engine optimization metadata of the target microsite based on the monitored user analytics, and then cause an updated version of the target microsite to be published on the ecommerce marketplace platform.

This feedback loop that is illustrated by the workflow 400 can be useful to assist vendors with modifying a microsite in order to increase sales of the vendors' products and/or services, which may otherwise be time-consuming and/or have a steep learning curve. As an example, assume that a first vendor uses a first page layout and a first color scheme on their microsite to advertise their products for the summertime and that a second vendor uses a second page layout and a second color scheme (e.g., that is different from the first page layout and the first color scheme) on their microsite to advertise their products for the summertime. In this example, also assume that the first vendor's sales of products through their microsite are much higher than the second vendor's sales of products through their microsite, and also that the products of the first and second vendors are similar in type, price, and quality. After the system determines that the first page layout and the first color scheme are at least partially causing the higher sales, the system can automatically update the second vendor's microsite to use the first page layout and the first color scheme, so that the second vendor can increase the sales of their products through their updated microsite.

FIG. 5 illustrates an overview workflow diagram 500 of the data-driven generative storefront system, according to some example embodiments.

At a high level, the data obtainment component 352 is configured to source or retrieve various inputs, e.g. text-based data, image-based data, video-based data, audio-based data, etc., that are then processed via one or more of the machine learning models and algorithms illustrated in the data processing component 354, also shown in FIG. 5. The output(s) of the machine learning models and the algorithms are then provided to the page generation component 356, which then generates various layouts, text, images, and other content for the microsites 340. In the description below for a given iteration of the workflow 500, a “target” microsite 340 may be used to describe a goal microsite that is currently being generated for publication onto the ecommerce marketplace platform 320.

As shown within the data obtainment component 352, a CMS 502 may be implemented using hardware and software of the data-driven generative storefront system 350.

The CMS 502 may include a repository of content that is published onto the ecommerce marketplace platform 320. The repository of content may be stored in the database system 330 that is made accessible to both the ecommerce marketplace platform 320 and the data-driven generative storefront system 350. The repository of content that is managed by the CMS 502 may include modules, templates, and layouts for the microsites 340. For example, the CMS 502 is configured to manage or have access to published microsites that have been previously or are still currently published via the ecommerce marketplace platform 320, data and metadata associated with vendors and brands, page modules, copy content, creatives, page layouts, different versions of microsite pages, product selections, search engine optimization metadata and keywords that are searchable by a web crawler, or other related features that may be relevant to the data-driven generative storefront system 350 and to the generation and maintenance of the microsites 340.

Creatives may include elements or content, such as images, videos, or other interactive media, that are designed to capture a viewer's attention when viewing a given microsite 340, and thus enhance the effectiveness of various digital advertising campaigns that are managed via the ecommerce marketplace platform 320.

Copy content may include headlines, slogans, product descriptions, promotional materials, and any other written content that may be used in marketing or advertising campaigns that are managed via the ecommerce marketplace platform 320.

Page modules may include sections or portions of the given microsite 340 page.

Search engine optimization may include a practice of increasing a quantity and quality of traffic to the microsites 340 and, thus collectively, to the ecommerce marketplace platform 320, through optimization of search engine results.

As shown within the data obtainment component 352, the inputs that the data obtainment component 352 is configured to source or retrieve may also include data from a product and service catalog 504. The product and service catalog 504 may include information about products that are sold both online and offline via the ecommerce marketplace platform 320. For example, the product and service catalog 504 may include features of products and services pertaining to the products.

As shown within the data obtainment component 352, the inputs that the data obtainment component 352 is configured to source or retrieve may also include data analytics, such as that which is illustrated by pulse/click feed 506 in FIG. 5. The pulse/click feed 506 may include user tracking for full funnel analytics, such as interactive click trajectory data, quantity and average product purchases per use purchase, search engine optimization clicks, average or overall user time spent based on scroll location prior to a sale and to corresponding creatives that are generated via creative generation 534 (additionally described below), data regarding increasing or decreasing trends or quantified user clicks, etc.

As shown within the data obtainment component 352, the inputs that the data obtainment component 352 is configured to source or retrieve may also include Sales/Events 508. The Sales/Events 508 inputs may include information about past and present events, such as upcoming or past sales being (that were) promoted via the ecommerce marketplace platform 320, upcoming or past holidays around the world, and other event-driven occasions, e.g., back-to-school shopping, seasonal clothing changes, national or country-specific holidays, etc.

As shown within the data obtainment component 352, the inputs that the data obtainment component 352 is configured to source or retrieve may also include brand safety policies 510. The brand safety policies 510 may refer to certain rules and regulations that are to be adhered to when publishing any content on the microsites 340 and thus, more globally, on the ecommerce marketplace platform 320. These brand safety policies 510 may be stored within database system 330 such that the information is accessible to the data-driven generative storefront system 350. The brand safety policies 510 may refer to the prevention of offensive or otherwise harmful content being published, for example. These may also refer to strategies and measures that are taken to ensure that online advertisements, published on the microsites 340, do not appear in contexts that could harm the reputation of the ecommerce marketplace platform 320.

Returning to the overview workflow diagram 500 of the data-driven generative storefront system shown in FIG. 5, the data processing component 354 may then be configured to process, via one or more of the machine learning models and algorithms, the inputs that are sourced by the data obtainment component 352. As shown in FIG. 5, the machine learning models and algorithms of the data processing component 354 determine a page layout, modules within the page, products shown within the page, and other image and video content related to the products shown within the page that collectively illustrate a target microsite that is generated via the methods and techniques shown in the workflow 500.

As shown by the data processing component 354, a classification and clustering algorithm 512 may be configured to group entities, e.g., brands, sellers, influencers, based on page content that is published for them. For example, the classification and clustering algorithm 512 may cluster a cohort of published microsites with a target microsite, based on a given threshold of similarity in respective features of the cohort of published microsites and the target microsite. If the target microsite pertains to a shoe brand, then the classification and clustering algorithm 512 may classify the target microsite as pertaining to shoes, and then cluster other shoe brands and shoe products that are identified based on inputs from the CMS 502 and the product and service catalog 504. This classification and clustering may then be used for a page module selection 524.

The classification and clustering algorithm 512 may be implemented using a classifier machine learning model or algorithm, and is additionally described herein with regard to workflow 600.

As shown by the data processing component 354, a multimodal LLM 514 may be configured to receive inputs from the product and service catalog 504, the sales/events 508, and from the brand safety policies 510, and, when executed, the multimodal LLM 514 may output copy content 528. The multimodal LLM 514 is additionally described herein with regard to workflow 700, 800, and 1100.

As shown by the data processing component 354, an image generation machine learning model 516 may be configured to generate the creatives 534 and, when executed, the image generation machine learning model 516 uses static algorithms or generative methods that are applied to product images from the product and service catalog 504 to output the creatives 534 for the target microsite. The image generation machine learning model 516 may be implemented as a text-to-image machine learning model or as an image-to-image machine learning model. For example, the image generation machine learning model 516 may be implemented as ImageGen.

As shown by the data processing component 354, a rule engine 518 may be configured to receive inputs such as the brand safety policies 510 and, when executed, conform content of the target microsite to search engine optimization 536.

As shown by the data processing component 354, a sequencer 520 may be configured to prioritize placements of images with respect to one another, products with respect to one another, and modules with respect to one another. The sequencer 520 may determine these placements within the overall page layout 526 of the target microsite 340 by receiving the pulse/click feed 506 inputs, in addition to outputs of the classification and clustering algorithm 512.

As shown by the data processing component 354, a reinforcement learning of a Bandit model 522 may also be used to ensure that the workflow 500 is updated over time via a continuous learning mechanism. The reinforcement learning of the Bandit model 522 may be configured to provide active feedback by learning what is contributing to enhanced performance and sales over time, and ensure that those methods, products, advertisement techniques, etc. are used going forward in the next version of the target microsite. The reinforcement learning of the Bandit model 522 may receive the pulse/click feed 506 and sales/events 508 inputs and, when executed, output active feedback for the page versioning 530. A similar type of active feedback may be applied for product selection 532 as well, wherein a number of products that are to be arranged and displayed on the target microsite are selected.

In some example embodiments, the sequencer 520 and the reinforcement learning of the Bandit model 522 are applied to optimize the page modules within the page module selection 524 in order to highlight and generate good user traction on the target microsite 340.

Returning to the overview workflow diagram 500 of the data-driven generative storefront system shown in FIG. 5, the page generation component 356 may then be configured to generate the target microsite 340 based on the combined outputs of the classification and clustering algorithm 512, the multimodal LLM 514, the image generation machine learning model 516, the rule engine 518, the sequencer 520, and the reinforcement learning of the Bandit model 522. The page modules, page layout, copy content, creatives, and selected products of the target microsite 340 are additionally described with regard to workflows 600, 700, 800, 900, 1000, and 1100 below.

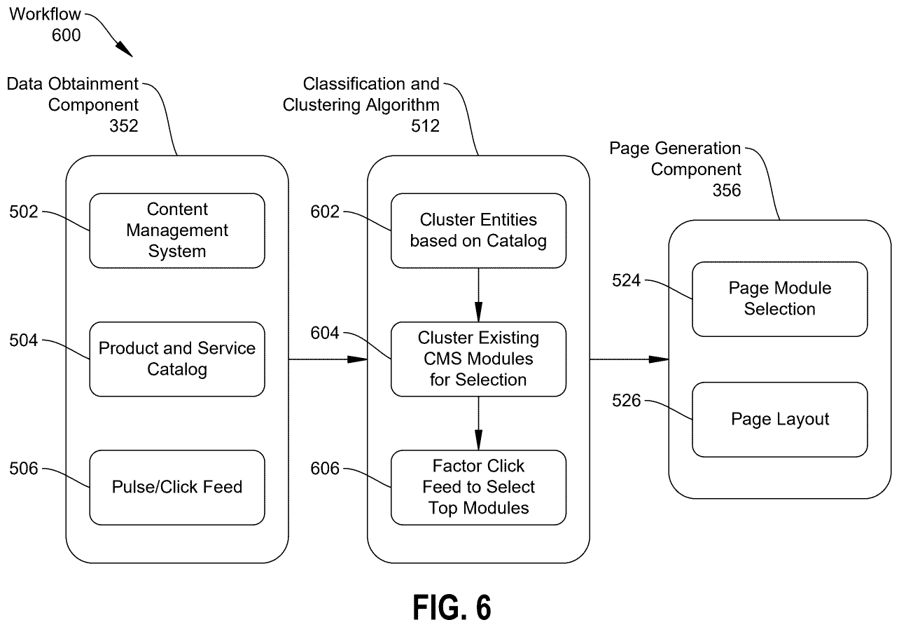

FIG. 6 is a workflow diagram 600 of the data-driven generative storefront system 350 that illustrates techniques for classification and clustering, according to some example embodiments.

As shown in FIG. 6, the data obtainment component 352 can provide retrieved, stored, user inputs and obtained data from the database system 330 or from the network 360 to the classification and clustering algorithm 512 with pre-extracted features or features to be extracted by the classification and clustering algorithm 512. The user input may include, for example, a generation LLM prompt for a target microsite by the user, delineated criterion, reference to brand page including relevant features, and pre-selected features for a target microsite and/or vendor, etc. Moreover, the pre-extracted features or features to be extracted may include data from the CMS 502, e.g. content published on the ecommerce marketplace platform 320 that can include page modules, templates, creatives, copy content, module arrangements, and page layouts, etc. This may also include data from the product and service catalog 504, information for products and services sold online and offline on the ecommerce marketplace platform 320, such as product types, service types, prices, e.g., advertised prices, MSRPs, and sales prices, product attributes, e.g., weights, colors, dimensions, uses, and functionality, etc., service attributes, e.g., sub-services, quantity of service providers, timeframes, locations, and fine print/limitations, etc., and data from the pulse/click feed 506, e.g., user tracking for full funnel analytics, qualitative/quantitative click trajectories to customer purchase and involved interactive links, creatives, copy content, etc., click amounts associated with specific products and/or services and by respective types, click amounts for one or more potential customers and/or one or more purchasing customers and averages, increasing/decreasing trends in the amount of clicks overall, for a given duration of time, or per user, increasing/decreasing trends in a general amount and/or a specific dollar value amount of sales per click, per user, average, for a given duration of time, or overall, user screen time associated with display of microsite contents, such as by creatives or copy content, overall, average, or for a given duration of time, etc.

The classification and clustering algorithm 512 can use the features, e.g., by extraction and/or pre-extracted features, to cluster and classify the microsites 340, e.g., a published or an unpublished target microsite along with a cohort of published microsites, e.g., from other vendors.

The classification and clustering algorithm 512 can cluster the microsites 340 based on a given threshold of similarity in the features and the classifications based thereon. For example, the clustering, illustrated by block 602, can be based on one or more of a given threshold of similarity in one or more of brands, vendor types, product types, product attributes, service types, service attributes, categories, prices, microsite contents, locations, and target audiences. Once the classification and clustering is performed, page modules are identified that are in use by at least some published microsites of the cohort of published microsites, as illustrated in block 604. Page modules can refer to sections of a microsite. Based on user interaction gathered from the published microsites, including click feed data, candidate modules, e.g., top performing modules, are selected and arranged by the page generation component 356 for the target microsite 340 according to a hierarchy of clicks by users overall, averaged, and based on a given duration of time. Unless overridden by a user 380, a module with the largest number of overall clicks by the users is selected, as indicated by block 606.

The outputs of the classification and clustering algorithm 512 are then provided for the page module selection 524 and the page layout 526, as shown in FIG. 5.

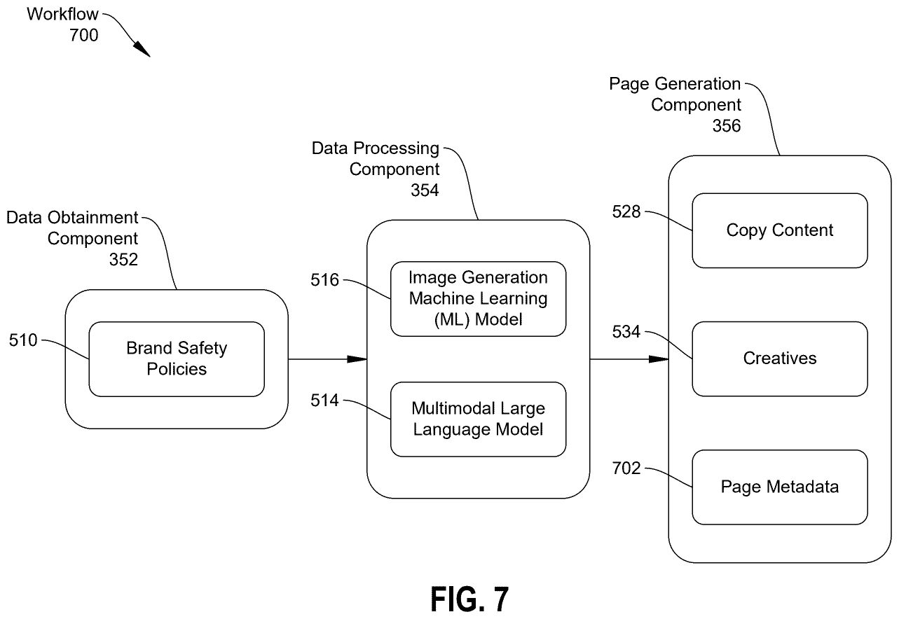

FIG. 7 is a workflow diagram 700 of the data-driven generative storefront system 350 that illustrates the use of brand safety policies when generating copy content, creatives, and page metadata using multiple machine learning models, according to some example embodiments.

As shown in FIG. 7, brand safety rules, policies and guidelines can be input into the generative machine learning models of the data processing component 354, such as the image generation machine learning model 516 and the multimodal LLM 514 as prompts, e.g., user prompts or a prompt generated by the multimodal LLM 514 and then provided to the image generation machine learning model 516, to verify that the target microsite 340 and components of the target microsite 340 are generated, e.g., copy content 528, creatives 534, and page metadata 702, etc., in compliance with policies and guidelines, such as for brand safety, of the ecommerce marketplace platform 320 and, in some example embodiments, of the user 380. These can be strategies and measures taken to ensure that online advertisements and published microsites do not appear in contexts that could harm reputations of the vendor and the ecommerce marketplace.

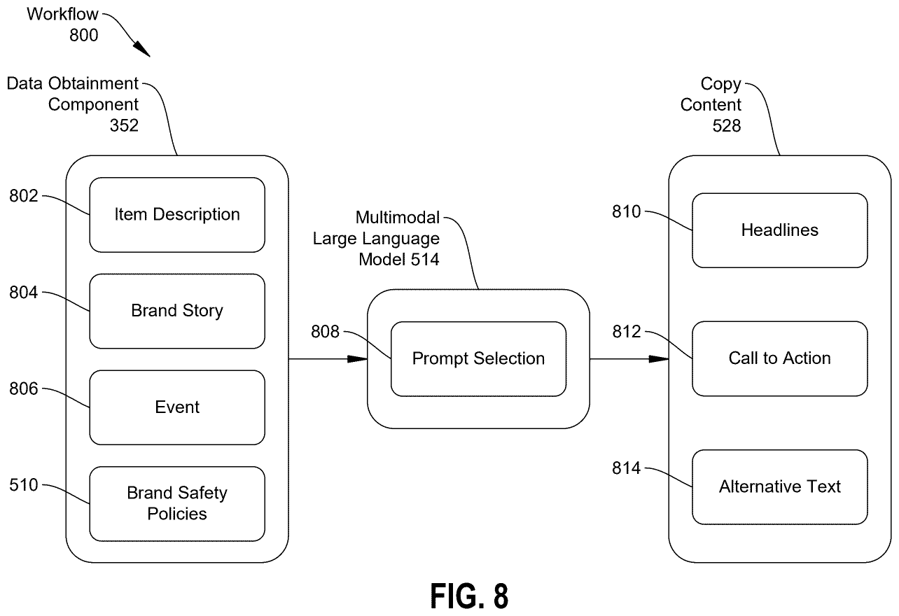

FIG. 8 is a workflow diagram 800 of the data-driven generative storefront system 350 that illustrates the use of a multimodal LLM 514 when generating the copy content 528, according to some example embodiments.

The workflow diagram 800 refers to a workflow that may occur sequentially after the page module selection 524 block shown in workflow 500. The selected page module is then provided again to the multimodal LLM 514 for further processing.

As shown in FIG. 8, the page module, as selected, can dictate corresponding copy content 528 for the target microsite 340. The copy content 528 can include headlines 810, call to action 812, alternative text 814, in addition to taglines, slogans, product and service descriptions, promotional materials, and any other written content that can be used in marketing and advertising campaigns.

The multimodal LLM 514, when executed, then generates a prompt 808 for further generating of the copy content 528. The multimodal LLM 514 can receive inputs, such as product and service related features and descriptions 802, a brand story 804, information about a temporal event 806, e.g., a holiday event or a sales event, information about an analytical event, e.g., user prompts, a trend of decrease in sales or clicks by the users, a product and/or service launch, etc., the brand safety policies 510 and guidelines, and other requirements of the page modules prior to publication to the ecommerce marketplace platform 320.

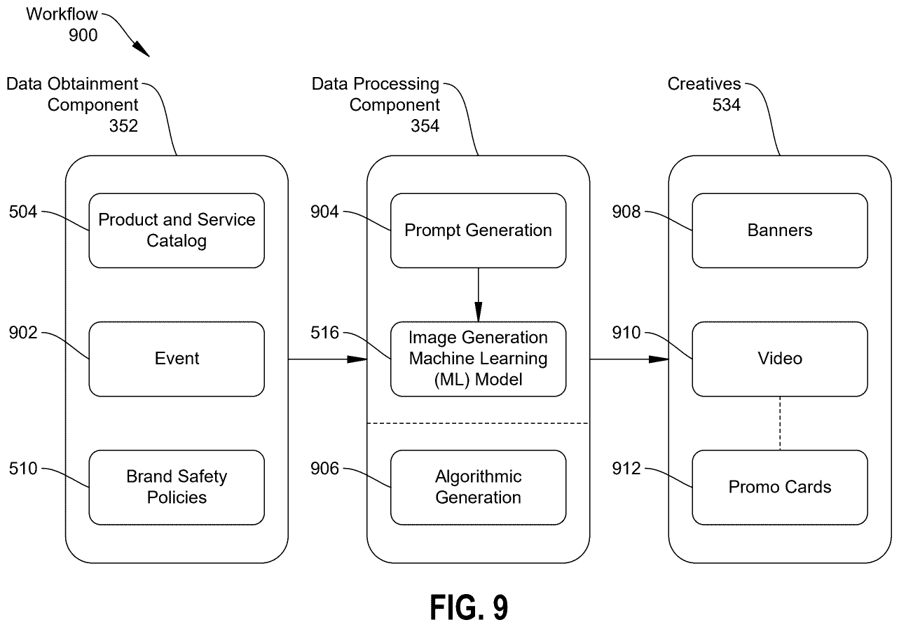

FIG. 9 is a workflow diagram 900 of the data-driven generative storefront system 350 that illustrates the use of an image generation machine learning model when generating the creatives, according to some example embodiments.

The workflow diagram 900 refers to a workflow that may occur sequentially after the page module selection 524 block shown in workflow 500. The selected page module is then provided to the image generation machine learning model 516 for further processing.

As shown in FIG. 9, the image generation machine learning model 516, when executed, may output various creatives 534. The 534 creatives may include engaging audio and visual elements, such as images, videos 910, sounds clips, jingles, banners 908, promotions 912, and interactive media, designed to capture audience's attention and enhance the effectiveness of digital advertising campaigns. Similar to the generation of the copy content 528 for the target microsite 340, the generation of the creatives 534 is dictated by the selected page module from the page module selection 524.

In some example embodiments, the creatives 534 can be generated based on executing an algorithm 906 with static placement of product and service images, e.g., a montage. In other embodiments, the creatives 534 can be generated based on executing the image generation machine learning model 516 after providing a prompt generation 904 to the image generation machine learning model 516.

For example, and when using the algorithm 906, popular products, e.g., event-based popular products 902, can be identified from the interaction data, e.g., the pulse/click feed 506 data, and these product images can be used as an input to generate a creative with the final image.

In another example and when using the image generation machine learning model 516, after the popular products are shortlisted, the multimodal LLM 514 can be used to first generate a prompt 904 to generate the creatives 534, e.g., the background, color scheme, and mood, in conjunction with the featured product and service, e.g., the product or service that is offered for sale and is being promoted, for the product images in the creatives 534. This generated prompt 904 by the multimodal LLM 514 for the generation of the creatives for the target microsite 340 is then provided to the image generation machine learning model 516 to output the generated creatives 534.

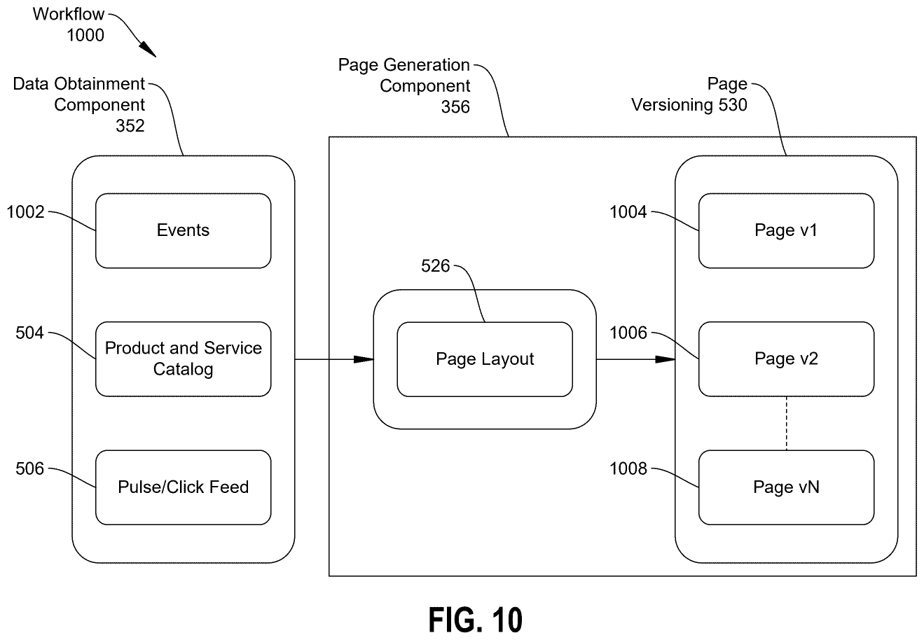

FIG. 10 is a workflow diagram 1000 of the data-driven generative storefront system 350 that illustrates the generation of multiple versions of pages 530, according to some example embodiments.

As shown in FIG. 10, one or more of the selected page module 524, the selected page layout 526, the copy content 528, and the creatives 534 can be autonomously selected or presented to a user for selection amongst multiple candidate page variations 530.

Holiday events 1002, the product and service catalog 504, sales, the pulse/click feed 506 trends, product launches, or A/B Tests can be an automated triggering condition for these candidate variations to be produced by the workflow 500. For example, in the case of holiday events and product launches, the page generation component 356 for the generating of the target microsite 340 can be thematic, according to the particular event, by engineering the required prompts, accordingly using methods and techniques described herein with regard to workflow 500. Multiple versions, e.g., page 1004, page 1006, page 1008, etc., of the same target microsite 340 can be generated.

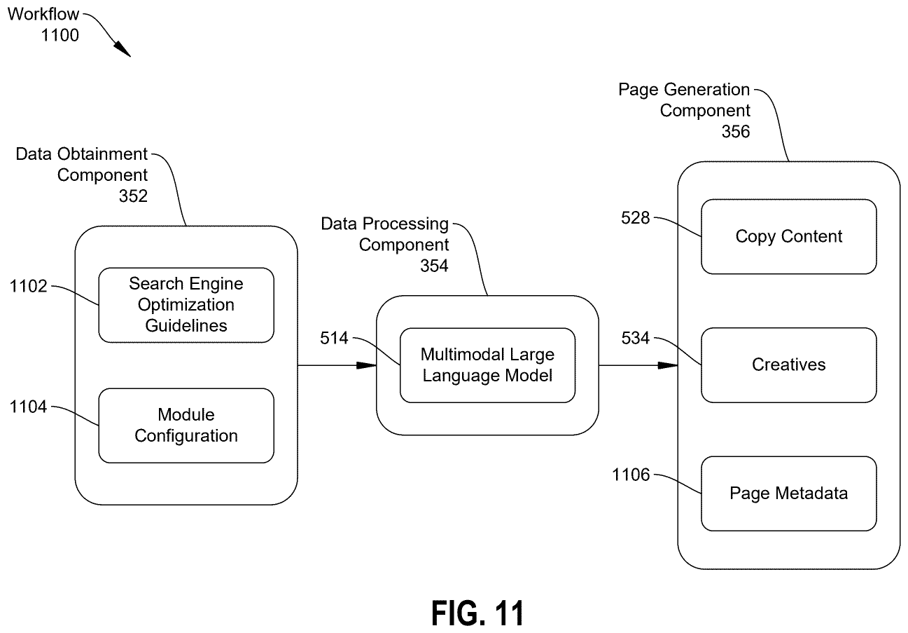

FIG. 11 is a workflow diagram 1100 of the data-driven generative storefront system 350 that illustrates the use of the multimodal LLM when generating the copy content, the creatives, and the page metadata.

As shown in FIG. 11, search engine optimization guidelines 1102 and module configuration 1104 may be provided to the multimodal LLM 514 which, when executed, generates the copy content 528, the creatives 534, and the page metadata according to the search engine optimization guidelines 1102, and, in some example embodiments, according to other rules associated with configuration of a particular page module of the target microsite 340.

The search engine optimized target microsite 340 pages help in indexing the digital storefront pages with respect to bots, e.g., web crawlers. To make the target microsite 340 and or sub-pages thereof search engine optimization friendly, the page metadata 1106 can be generated by the multimodal LLM 514 about the page using the context used for generation, thus making the data contained in the metadata and keywords thereof readily available for bots to intake.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although generating data-driven microsites has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of these embodiments does not necessarily represent a complete description of all possible embodiments. For example, one or more of the procedures, processes, or activities of FIGS. 4-11 may include different procedures, processes, and/or activities and be performed by many different modules, in many different orders. As another example, the systems and engines within the system 300 and workflow 500 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing program instructions that, when executed on the processor, cause the processor to:
identify a triggering condition, wherein the triggering condition comprises criteria regarding a user-initiated event, a temporal event, or an analytical event;
cause a target microsite to be generated for an ecommerce marketplace platform based on the criteria, wherein, to generate the target microsite, the program instructions further cause the processor to:
classify, via a classification and clustering algorithm, the target microsite as pertaining to a given class of products or services based on the criteria and on information from a product and service catalog;
cluster, via the classification and clustering algorithm, a set of published microsites that correspond to the target microsite based on a given threshold of similarity in respective features of the set of published microsites and the target microsite;
select, via the classification and clustering algorithm, a given page module from a given one of the set of published microsites that is identified as being associated with a higher user click feed data than another page module from the given set of published microsites; and
generate a page layout for the target microsite based, at least in part, on the selected page module; and
cause the target microsite to be published on the ecommerce marketplace platform according to the page layout.

2. The system of claim 1, wherein the temporal event comprises an upcoming sale or upcoming holiday.

3. The system of claim 1, wherein:
the user-initiated event comprises a user-generated prompt provided to a multimodal large language model; and
the user-generated prompt comprises the criteria for the generation of the target microsite.

4. The system of claim 1, wherein the analytical event comprises at least one of a product launch, a decrease in sales, or a decrease in user click feeds.

5. The system of claim 1, wherein the program instructions further cause the processor to:
generate copy content, a creative, or search engine optimization metadata of the target microsite, in addition to the page layout; and
cause the target microsite to be published on the ecommerce marketplace platform according to the page layout and to the copy content, the creative, or the search engine optimization metadata of the target microsite.

6. The system of claim 5, wherein, to generate the copy content, the creative, or the search engine optimization metadata of the target microsite, the program instructions further cause the processor to verify that the copy content, the creative, or the search engine optimization metadata of the target microsite are in compliance with brand safety policies, wherein the search engine optimization metadata comprises keywords that are searchable by a web crawler.

7. The system of claim 1, wherein, to generate the target microsite, the program instructions further cause the processor to:
provide multiple candidate variations of the target microsite to a user prior to publication of the target microsite, wherein the candidate variations differ from one another in at least one of page layouts, copy contents, creatives, search engine optimization metadata, or a number of products offered for sale on the target microsite; and
receive an indication from the user regarding a given one of the candidate variations to be used when the target microsite is published on the ecommerce marketplace platform.

8. The system of claim 1, wherein the respective features of the set of published microsites comprise at least one of categories, attributes, contents, locations, target audiences, and at least one of target users, products offered for sale, product descriptions, or brand stories.

9. The system of claim 1, wherein the program instructions further cause the processor to:
after the publication of the target microsite, monitor user analytics pertaining to the published target microsite;
update at least one of copy content, arrangement of the page layout, the page module, a creative, or search engine optimization metadata of the target microsite based on the monitored user analytics; and
cause an updated version of the target microsite to be published on the ecommerce marketplace platform.

10. The system of claim 1, wherein:
the target microsite is implemented as a digital storefront for a seller of at least one of a product or service; and
the ecommerce marketplace platform comprises an ecommerce marketplace website for multiple sellers comprising the seller.

11. A method of generating data-driven microsites, the method comprising:
identifying a triggering condition, wherein the triggering condition comprises criteria regarding a user-initiated event, a temporal event, or an analytical event;
generating a target microsite to be published on an ecommerce marketplace platform based on the criteria, wherein, the generating the target microsite comprises:
classifying, via a classification and clustering algorithm, the target microsite as pertaining to a given class of products or services based on the criteria and on information from a product and service catalog;
clustering, via the classification and clustering algorithm, a set of published microsites that correspond to the target microsite based on a given threshold of similarity in respective features of the set of published microsites and the target microsite, wherein the respective features comprise at least one of categories, attributes, contents, locations, or target audiences;
selecting, via the classification and clustering algorithm, a given page module from a given one of the published microsites that is identified as being associated with a higher user click feed data over a given interval of time than another page module from the given set of published microsites; and
generating a page layout for the target microsite based, at least in part, on the selected page module; and
publishing the generated target microsite on the ecommerce marketplace platform according to the page layout.

12. The method of claim 11, wherein the generating the target microsite further comprises:
providing multiple candidate variations of the target microsite to a user prior to publication of the target microsite, wherein the candidate variations differ from one another in at least one of page layouts, copy contents, creatives, search engine optimization metadata, or a number of products offered for sale on the target microsite; and
receiving an indication from the user regarding a given one of the candidate variations to be used when the target microsite is published on the ecommerce marketplace platform.

13. The method of claim 11, further comprising extracting the respective features of the target microsite from at least one of user input data, content management system data, product and service catalogue data, user analytics data, or brand safety policy data.

14. The method of claim 11, wherein the temporal event comprises an upcoming sale or upcoming holiday.

15. The method of claim 11, wherein the analytical event comprises at least one of a product launch, a decrease in sales, or a decrease in user click feeds.

16. The method of claim 11, further comprising:
generating copy content, a creative, or search engine optimization metadata of the target microsite, in addition to the page layout; and
publishing the target microsite on the ecommerce marketplace platform according to the page layout and to the copy content, the creative, or the search engine optimization metadata of the target microsite.

17. A method for generating data-driven microsites, the method comprising:
identifying a triggering condition, wherein the triggering condition comprises criteria regarding a user-initiated event, a temporal event, or analytical event;
generating a target microsite to be published on an ecommerce marketplace platform based on the criteria, wherein, the generating the target microsite comprises:
classifying, via a classification and clustering algorithm, the target microsite as pertaining to a given class of products or services based on the criteria and on information from a product and service catalog;
clustering, via the classification and clustering algorithm, a set of published microsites that correspond to the target microsite based on a given threshold of similarity in respective features of the set of published microsites and the target microsite;
selecting, via the classification and clustering algorithm, a given page module from a given one of the published microsites that is identified as being associated with a higher user click feed data over a given interval of time than another page module from the given set of published microsites; and
generating a page layout for the target microsite, wherein the generating the page layout for the target microsite comprises modifying a page layout of the published microsite that corresponds to the selected page module; and
publishing the generated target microsite on the ecommerce marketplace platform.

18. The method of claim 17, wherein the generating the page layout for the target microsite further comprises arranging copy content and creatives within the page layout based on a ranking of click feeds that correspond to the copy content and the creatives.

19. The method of claim 17, further comprising extracting the respective features of the target microsite from at least one of user input data, content management system data, product and service catalogue data, user analytics data, or brand safety policy data.

20. The method of claim 17, wherein the generating the target microsite further comprises:
providing multiple candidate variations of the target microsite to a user prior to publication of the target microsite, wherein the candidate variations differ from one another in at least one of page layouts, copy contents, creatives, search engine optimization metadata, or a number of products offered for sale on the target microsite; and
receiving an indication from the user regarding a given one of the candidate variations to be used when the target microsite is published on the ecommerce marketplace platform.
